(19) United States
(12) Patent Application Publication
(10) Pub. No.: US 2019/0103043 A1
(43) Pub. Date: Apr. 4, 2019

(54) AIRCRAFT OVERHEAD SIGNS

(71) Applicant: Saf-T-Glo Limited, Cwmbran (GB)

(72) Inventors: Sean O'Kell, Cwmbran (GB); Lauren Fleming, Cwmbran (GB); Robert Trundle, Cwmbran (GB)

(21) Appl. No.: 16/148,641

(22) Filed: Oct. 1, 2018

(30) Foreign Application Priority Data
Oct. 2, 2017 (GB) 1716087.0

(51) Int. Cl. G09F 13/22; B64D 11/00

(52) U.S. Cl. CPC G09F 13/22; G09F 2013/227; G09F 2013/222; B64D 11/00

(57) ABSTRACT

An aircraft passenger service unit placard comprising an integrated unit adapted to be retrofitted to an existing passenger service unit having a bi-pin lamp connection, the integrated unit comprising at least a first signage area and having at least one low energy illumination means arranged to illuminate the signage area, wherein the low energy illumination mean is optionally an LED unit and wherein the integrated unit comprises a first layer and a second layer separated by a light guide and wherein the illumination means is arranged as a side light in the light guide between the first layer and the second layer, the integrated unit further comprising at least one flexible connector arranged and adapted to connect to the bi-pin connection.

### CROSS-REFERENCE TO RELATED PATENT APPLICATIONS

This application claims priority to and the benefit of United Kingdom Priority Application 1716087.0, filed Oct. 2, 2017, the entire disclosure of which, including the specification, drawings, claims and abstract, is incorporated herein by reference in its entirety.

### BACKGROUND

This application relates to overhead signs in aircraft particularly signs located in passenger service units.

Typically, aircraft are provided with overhead signs located in a passenger service unit. Overhead signs are used to provide information to the passengers for the duration of the journey. The signs may provide information to passengers such as a no-smoking sign and when seat belt should be fastened. Other information may be provided on the overhead signs.

Such signs are provided in current passenger service units and are illuminated by switchable (on/off) incandescent lamps arranged to illuminate the signage in a placard. In existing passenger service units, it is typical to have two signage areas; each illuminated using two lamps each pair of lamps is independently controllable. It will be appreciated that having a large number of individual lamps creates a maintenance and service burden.

Aircraft have long service lives and over the period of use it may be desirable to update the cabin interior to provide a more modern appearance. It is also desirable to be able to change the aircraft signage in order to accommodate new safety requirements and to provide new features in the signage. Additionally it is desirable to reduce the maintenance burden.

It would be advantageous to provide a system that addresses these and other issues as may be apparent to those reviewing the present disclosure.

### SUMMARY

According to an exemplary embodiment, there is provided an aircraft passenger service unit placard comprising an integrated unit adapted to be retrofitted to an existing passenger service unit having a bi-pin lamp connection, the integrated unit comprising at least a first signage area and having at least one low energy illumination means arranged to illuminate the signage area, wherein the low energy illumination mean is optionally an LED unit and wherein the integrated unit comprises a first layer and a second layer separated by a light guide and wherein the illumination means is arranged as a side light in the light guide between the first layer and the second layer, the integrated unit further comprising at least one flexible connector arranged and adapted to connect to the bi-pin connection.

According to another exemplary embodiment, there is provided a method of retrofitting signage in an aircraft passenger service unit, the signage comprising a placard adapted to be fitted into an existing aircraft passenger service unit having at least one bi-pin lamp connection; the placard comprising an integrated unit having at least a first signage area and having at least one low energy illumination means arranged to illuminate at least the first signage area, wherein the low energy illumination means is optionally an LED unit, and wherein the integrated unit comprises a first layer and a second layer separated by a light guide, the illumination means being arranged a s a side light in the light guide between the first layer and the second layer, the integrated unit further comprising at least one flexible connector arranged and adapted to connect to the bi-pin connection, the method comprising removing an existing placard, optionally removing an existing lamp from the bi-pin lamp connection, connecting the at least one flexible connector of the integrated unit to an electrical power supply in the passenger service unit by connection to the bi-pin connection and securing the integrated unit to the passenger service unit.

### BRIEF DESCRIPTION OF THE DRAWINGS

The inventions will now be described by way of example only with reference to the accompanying drawings in which:

FIG. 1 is a perspective view of a section of a placard showing illuminated signage according to an exemplary embodiment;

FIG. 2 is an exploded view of the section of placard of FIG. 1; and

FIG. 3 is a perspective view of a placard according to an exemplary embodiment; and

FIG. 4 is view of a placard for fitting to a passenger service unit in an aircraft according to an exemplary embodiment.

### DETAILED DESCRIPTION

According to an exemplary embodiment, there is provided an aircraft passenger service unit placard comprising an integrated unit adapted to be retrofitted to an existing passenger service unit having a bi-pin lamp connection, the integrated unit comprising at least a first signage area and having at least one low energy illumination means arranged to illuminate the signage area, wherein the low energy illumination mean is optionally an LED unit and wherein the integrated unit comprises a first layer and a second layer separated by a light guide and wherein the illumination means is arranged as a side light in the light guide between the first layer and the second layer, the integrated unit further comprising at least one flexible connector arranged and adapted to connect to the bi-pin connection.

According to another exemplary embodiment, there is provided a method of retrofitting signage in an aircraft passenger service unit, the signage comprising a placard adapted to be fitted into an existing aircraft passenger service unit having at least one bi-pin lamp connection; the placard comprising an integrated unit having at least a first signage area and having at least one low energy illumination means arranged to illuminate at least the first signage area, wherein the low energy illumination means is optionally an LED unit, and wherein the integrated unit comprises a first layer and a second layer separated by a light guide, the illumination means being arranged a s a side light in the light guide between the first layer and the second layer, the integrated unit further comprising at least one flexible connector arranged and adapted to connect to the bi-pin connection, the method comprising removing an existing placard, optionally removing an existing lamp from the bi-pin lamp connection, connecting the at least one flexible connector of the integrated unit to an electrical power supply in the passenger service unit by connection to the bi-pin connection and securing the integrated unit to the passenger service unit.

In some embodiments, the integrated unit may have more than one signage area. According to one particular embodiment, the integrated unit comprises at least a second signage area. It may be desirable that the placard has at least one signage area arranged to be illuminated independently of another signage area. The placard may comprise a second illumination means arranged to illuminate at least the second signage area independently of the first signage area,

The integrated unit comprises a first layer and a second layer. The first and the second layers are separated by a light guide. The light guide may in one embodiment comprise a patterned transparent plastic with a light diffracting grid design. This grid pattern may comprise dots of white diffractive material. In a particular exemplary embodiment, the dots may increase in size as a distance from the light. It is believed that this arrangement provides a uniform signage display.

In some embodiments, the illumination means may be arranged to illuminate more than one signage area. In other embodiments a dedicated illumination means may be provided for each signage area. In some embodiments the second illumination means may be arranged to illuminate more than one signage area.

The illumination means may comprise an LED unit having one LED or more than one LED. The illumination means may be arranged to directly illuminate an icon. The illumination means is arranged to illuminate a light guide between the first and second layers of the integrated unit. The illumination means is arranged as a sidelight in the light guide between the first and second layers. The illumination means may be provided at or near an edge of the placard.

In some embodiments, a light guide may be provided to conduct the light from the illumination means to the icon. The light guide may include a light coloring means. The light coloring means may be a colored filter.

According to an exemplary embodiment, the integrated unit comprises at least one illumination means switchable between at least an on and an off condition. In a particular embodiment, one or more of the illumination means are adapted to be connected to an electrical power supply via the passenger service unit.

According to an exemplary embodiment, the integrated unit comprises one or more illumination means each of which are connected to an electrical power supply via the passenger service unit. Desirably the illumination means is linked to an electrical connector. The electrical connector may be arranged to connect to a bi-pin socket such as is typically provided in existing passenger service units.

According to an exemplary embodiment, the low energy illumination comprises at least one LED unit. Each LED unit may comprise one or more LEDs.

It will be appreciated that more than one LED unit may be provided for a particular signage area. The number of LED units used may depend on the area of the signage, the power of the LEDs in the unit and the brightness of sign required. A number of LEDs may be combined to control a light color output. The LED unit or units may be selected to output a colored light. A color of the light may be selected by selection of suitable LED units or LEDs in a unit. In other embodiments a colored film may be provided in the signage area to provide a colored sign or icon in the in signage area.

Desirably the placard further comprises at least one signage area that is permanently lit even when no power is supplied.

In one embodiment, the permanently lit signage area is lit by an LED unit that is controlled to be in an on condition when the aircraft is in use or when the aircraft is in flight.

Optionally the permanently lit area is provided with photoluminescent material. Desirably the permanently lit area has an icon comprising a non-smoking sign. Since the vast majority of flights are now non-smoking the non-smoking sign has to be lit at all times, contrary to past requirements in which the non-smoking sign only had to be lit during takeoff and landing. Photoluminescent material can provide an icon that is constantly illuminated without drawing on the aircraft electrical power supply. This has an advantage of reducing drain on the electrical supply of the aircraft.

Desirably, the integrated unit is adapted to connect to an existing passenger service unit installed in an aircraft. Typically existing passenger service units comprise one or more bi-pin lamp connector into which an incandescent lamp can be inserted. Such lamps typically comprise a lighting portion, a body and a pair of legs extending from the body and adapted to be inserted in cooperating socket formations of the bi-pin lamp connector in the passenger service unit. The socket formations provide a connection between the incandescent lamp and the electrical power supply of the passenger service unit. The passenger service unit is connected to the aircraft power supply system. The placard comprises at least one flexible connector. The flexible connector may comprise a pair of flexible leads. The flexible leads may be arranged to be insertable into the cooperating socket formation in the passenger service unit.

According to an exemplary embodiment, the integrated unit can be clipped into place in the passenger service unit.

According to an exemplary embodiment, the integrated unit is provided with a number of signage areas on the first surface. Desirably each signage area has one or more icons. Icons may provide information for, amongst other things, fastening seat belts, activation of a call button, non-smoking, availability of in-flight WiFi etc. It will be appreciated that additional icons may be included in signage areas of the first surface. The icons may be selected or varied depending on the information that is to be conveyed to the passengers.

In addition branding and art work may be provided that is related to the airline. The airline artwork and branding may be illuminated before takeoff or during the whole of the flight or during designated portions of the flight.

In some arrangements, the illuminated icons or artwork are white. In other embodiments that placard may be arranged such that one or more illuminated icons are colored. Introduction of color to the icons may be by the use of colored film, or colors may be provided by the use of colored LEDs or by other means.

In some embodiments, the illumination means is arranged to directly light at least one icon. At least one illumination means is offset from the icon or signage area. The light is arranged to travel through the light guide between the first layer and the second.

Colors used in the placard can be selected to be airline branding colors. In addition WiFi icons may be arranged to be illuminated in a blue light. Red illumination may be used to draw attention to icons such as “fasten seatbelt” signs. The non-smoking sign may also be illuminated in red.

An LED unit is provided in a space between the second surface and the outer surface. The LED unit may be one LED or a plurality of LEDs. The LED unit may provide a white light or a colored light. A colored light can be produced by a selecting an appropriately colored LEDs or a combination of appropriately colored LEDs. A colored light emission can be achieved by use of a colored film. The colored film may be provided on the first surface or between the light source and the signage area.

The colored film can be located adjacent an icon or on the first layer of the placard.

The placard may be arranged to have a low contrast between the icons and background when the icons are not illuminated. An advantage of this is that passengers are less likely to see the icons or indicia as being lit when they are not illuminated so that confusion is reduced. Additionally a low contrast between the indicia and the background may provide an aesthetically pleasing harmony and refreshed modern appearance in keeping with other aspects of modern aircraft interiors.

The first surface may have a dark coloration. In some embodiments the first surface of the first layer of the placard may be black or a dark grey. In some embodiments the or each icon is formed of a different color. The first layer may comprise a polycarbonate. In some embodiments the first layer may comprise a polycarbonate having a film applied to at least one of an inner and an outer surface of the polycarbonate. In other embodiments the placard may comprise a dark film co-extruded with the first layer. In other embodiments the polycarbonate may be colored.

In some embodiments, the icon comprises a clear portion of the first layer. The or each icon may comprise a clear portion of a film applied to the first surface of the first layer of the placard.

The or each icon may comprise a colored film applied to the first surface of the placard.

In some embodiments, photoluminescent material is used to provide a permanent signage. The photoluminescent material may be selected to transmit light in red wavelengths. Alternatively the photoluminescent material may transmit green to yellow wavelengths and a colored film may be provided such that red light is transmitted. The colored film may be arranged to allow red light to transmit through the film. The colored film may be arranged to absorb light of wavelengths other than red.

In some embodiments, each icon is illuminated by an LED unit. The LED unit may be dedicated to the respective icon. Desirably the or each LED unit is switchable between an on and an off condition. In some arrangements all of the LED units are switchable between an on and an off condition. In other embodiments one or more LED units are always in the on condition.

It will be appreciated that LED units are more reliable than the incandescent lamps that have been conventionally used to date. In addition it has been found that LED units have a longer lifetime. Replacing a conventional placard with a placard in accordance with the exemplary embodiments discussed herein has an advantage to the airline in increasing the working lifetime of the passenger service signage illumination and significantly reducing the maintenance required to ensure that all of the icons are working. In so doing safety of passengers is also increased as each passenger is more reliably provided with appropriate and accurate safety and informational signage.

Desirably the placard is made from non-flammable materials. According to an exemplary embodiment, at least the first layer of the placard is made of a scratch resistant material. In some embodiments at least the first surface of the first layer of the placard has a scratch resistant surface.

It is desirable that the placard cannot be damaged by a passenger either deliberately or accidentally. According to some exemplary embodiments, the placard is arranged to be tamper-proof or tamper-resistant.

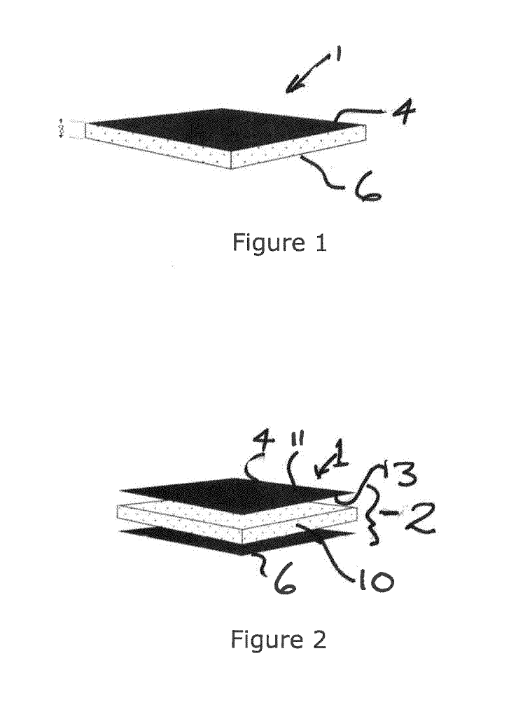

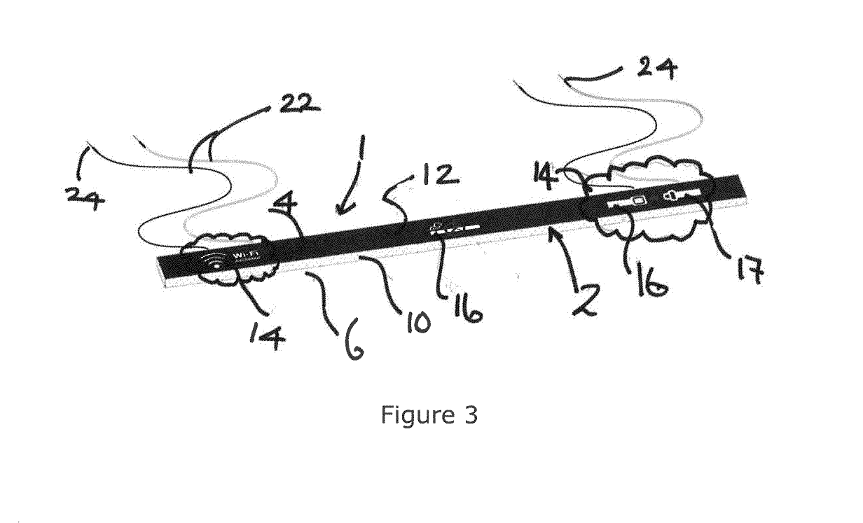

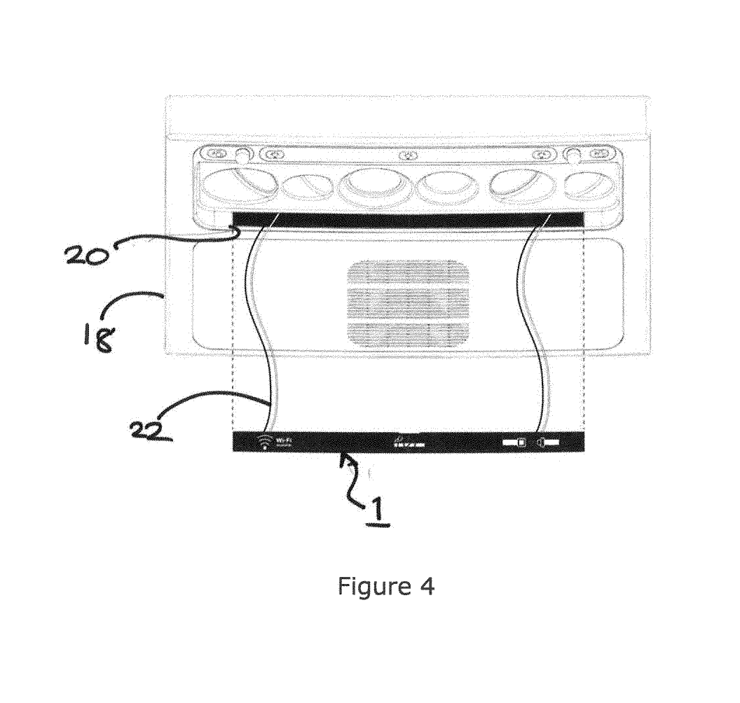

Turning now to the accompanying figures, FIG. 1 illustrates a placard 1 in accordance with an exemplary embodiment. The placard 1 comprises an integrated unit 2 having a first layer 4 and a second layer 6 separated by a distance 8 by a light guide 10. The light guide resides in the gap between the second layer 6 and the first layer 4.

The first layer 4 comprises a polycarbonate layer having an inner surface 13 and an outer surface 11. The outer surface of the first layer comprises a background 12 having a number of signage areas 14. Each signage area 14 comprises at least one icon 16. The icon 16 may be selected from warning icons such as “fasten seatbelt” signs and “no smoking” signs or may be informational such as “WiFi” signs or “Attendant” icons. Additional signage may be provided in the form of airline branding.

In this embodiment, each indicia 16 comprises a clear portion 17 of the first layer 4 through which light is transmitted.

An LED unit is provided in a space between the second layer 6 and the first layer 4. The LED unit may be one LED or a plurality of LEDs. The LED unit may provide a white light or a colored light. A colored light can be produced by a selecting an appropriately colored LED or a combination of appropriately colored LEDs. A colored light emission can also be achieved by use of a colored film.

The number of LEDs or the brightness of the or each LED is selected such that the icons relating to safety have a contrast ration of 10:1 against the outer surface of the first layer 4.

A color of each indicia 16 is controlled by appropriate selection of the LEDs used to illuminate the icon.

The colored film, if used, can be located adjacent the indicia 16 on at least a portion of the first layer 4 of the placard and may be on the outer surface.

Each LED unit has an electrical connector in the form of a pair of flexible leads 22 which extend from the rear of the placard. The electrical connector is arranged to be connect to a bi-pin connector typically used in passenger service unit for lighting conventional placards. Such bi-pin connectors are typically provided in the form of a pair of sockets arranged to receive the connectors from a typical incandescent light bulb. The placard has a pair of flexible leads that are adapted and arranged to extend from the placard and to be inserted in the sockets to connect with the electrical supply in the passenger service unit and from thence to the aircraft electrical power system. Each lead is provided with a component 24 adapted to connect into one of the bi-pin sockets. Using a pair of flexible leads improves the flexibility of the connection and allows the leads to be connected to the switchable power supply in the passenger service unit. In some cases, the sockets in the passenger service unit may be located in different regions of an aperture in the passenger service unit. The flexible leads can be connected to the sockets in a variety of locations. A pair of leads may be provided at each end of the placard. It will be appreciated that the flexible connector may comprise a pair of flexible leads or in other embodiments may be a flexible lead with a pair of components adapted to connect to the b-pin socket.

The LED unit can be controlled to be in an off state or an on state by conventional switches in the cockpit which are operated by the aircraft crew. Typically the switches in the cockpit are arranged to control electrical supply to the bi-pin connectors. It is also envisaged that alternative control means may be used.

In some embodiments, a single power supply may be utilized.

Each placard 1 is arranged to connect to an existing passenger service unit, generally indicated at 18 and is shaped to fit to a corresponding aperture 20 in the passenger service unit. The shape of the integrated unit of the placard is such that it fits into the passenger service unit 18 and cooperates with existing securing means. Bi pin connectors are typically provided at each end of the aperture. The bi-pin connectors are in the form of a pair of sockets (not shown).

The integrated unit 1 is shaped such that it cooperates with an existing passenger service unit 18 and can be clipped into place instead of a conventional placard. The integrated unit is shaped such that the unit is at least tamper resistant and may be tamper proof.

The first layer is formed of a polycarbonate and has a scratch resistant outer surface.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the Figures. It should be noted that the orientation of various elements may differ according to other exemplary embodiments, and that such variations are intended to be encompassed by the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the systems as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. An aircraft passenger service unit placard comprising an integrated unit adapted to be retrofitted to an existing passenger service unit having a bi-pin lamp connection, the integrated unit comprising at least a first signage area and having at least one low energy illumination means configured to illuminate at least the first signage area, wherein the integrated unit comprises a first layer and a second layer separated by a light guide and wherein the illumination means is arranged as a side light in the light guide between the first layer and the second layer, the integrated unit further comprising at least one flexible connector arranged and adapted to connect to the bi-pin connection.

2. The placard of claim 1, wherein the illumination means comprises one or more LED units.

3. The placard of claim 2, wherein the LED units are configured to provide at least one of a predetermined brightness, color, or light output.

4. The placard of claim 1, wherein the placard comprises a second signage area.

5. The placard of claim 4, wherein the placard comprises a second illumination means configured to illuminate the second signage area independently of the first signage area.

6. The placard of claim 5, wherein the second illumination means is configured to directly illuminate the second signage area.

7. The placard of claim 1, wherein the illumination means is configured to illuminate more than one signage area.

8. The placard of claim 1, wherein the integrated unit is configured to be connectable to an existing electrical power supply via the passenger service unit and at least one illumination means is switchable between at least an on and an off condition.

9. The placard of claim 1, wherein the placard further comprises at least one signage area that is permanently lit.

10. The placard of claim 9, wherein the at least one signage area that is permanently lit is lit by photoluminescent material.

11. The placard of claim 1, wherein the or each signage area comprises an icon arranged to be one of:
a) white or
b) colored.

12. The placard of claim 11, wherein the icon is arranged to be colored and wherein the icon is colored by one of:
i) a colored LED;
ii) a combination of colored LEDs; or
iii) a colored and positioned film.

13. The placard of claim 1, wherein the integrated unit is arranged to be tamper-proof and/or tamper-resistant.

14. A method of retrofitting signage in an aircraft passenger service unit comprising:
providing a placard adapted to be fitted into an existing aircraft passenger service unit having at least one bi-pin lamp connection, the placard comprising an integrated unit having at least a first signage area and having at least one low energy illumination means arranged to illuminate at least the first signage area, wherein the integrated unit comprises a first layer and a second layer separated by a light guide, the illumination means being arranged as a side light in the light guide between the first layer and the second layer, the integrated unit further comprising at least one flexible connector arranged and adapted to connect to the bi-pin connection;
removing an existing placard; and
connecting the at least one flexible connector of the integrated unit to an electrical power supply in the passenger service unit by connection to the bi-pin connection and securing the integrated unit to the passenger service unit.

15. The method of claim 14, wherein the illumination means comprises one or more LED units.

16. The method of claim 15, wherein the LED units are configured to provide at least one of a predetermined brightness, color, or light output.

17. The method of claim 14, further comprising removing an existing lamp from the bi-lamp pin connection.
